(19) United States
(12) Patent Application Publication
(10) Pub. No.: US 2022/0413500 A1
(43) Pub. Date: Dec. 29, 2022

(54) System and Method for Robotic Mission Planning & Routing

(71) Applicants: Ben Eazzetta, Vienna, VA (US); John A. Halsema, Vienna, VA (US); Christopher A. Guryan, Vienna, VA (US); Greg Richardson, Vienna, VA (US)

(72) Inventors: Ben Eazzetta, Vienna, VA (US); John A. Halsema, Vienna, VA (US); Christopher A. Guryan, Vienna, VA (US); Greg Richardson, Vienna, VA (US)

(21) Appl. No.: 17/853,745

(22) Filed: Jun. 29, 2022

Related U.S. Application Data
(60) Provisional application No. 63/216,040, filed on Jun. 29, 2021.

(51) Int. Cl. G05D 1/02; G05D 1/10; G06N 7/00

(52) U.S. Cl. CPC G05D 1/0212; G05D 1/0287; G05D 1/104; G06N 7/005; G05D 2201/0209

(57) ABSTRACT

A method of using robotic units to provide security for a site, the method comprising: creating a digital twin of the site; using a pathing engine to model and determine possible robotic unit paths around the site; and using the digital twin and possible robotic unit paths to create numerous permutations of a security mission plan for the site.

### CROSS REFERENCE TO RELATED APPLICATIONS

This application claims priority to, and the benefit of, pending U.S. Provisional Patent Application No. 63/216,040 filed on Jun. 29, 2021.

### FIELD OF THE DISCLOSURE

The present disclosure pertains to the field of robotic security, inspection, and mission planning

### FIGURES

To further illustrate the advantages and features of the present disclosure, a more particular description of the invention will be rendered by reference to specific embodiments thereof which are illustrated in the appended drawings. It is appreciated that these drawings are not to be considered limiting in scope. The invention will be described and explained with additional specificity and detail through the use of the accompanying drawings in which:

FIG. 1 shows the system architecture/flow chart for one embodiment of the present invention.

FIG. 2 shows one embodiment of a user interface screen of the present invention.

FIG. 3 shows one embodiment of a user interface screen of the present invention.

FIG. 4 shows one embodiment of a user interface screen of the present invention.

FIG. 5 shows one embodiment of a user interface screen of the present invention.

FIG. 6 shows one embodiment of a user interface screen of the present invention.

FIG. 7 shows one embodiment of a user interface screen of the present invention.

FIG. 8 shows one embodiment of a user interface screen of the present invention.

FIG. 9 shows one embodiment of a user interface screen of the present invention.

FIG. 10 shows one embodiment of a user interface screen of the present invention.

### BACKGROUND

Current methods of conducting remote site monitoring, physical security rounds, response, and site inspection are labor intensive, costly, and often fail to consider human factors that often prohibit effective personnel performance or safety.

In most cases, these missions are repetitive, boring, often happen at odd hours, and are preceded by hours of inactivity. The conditions can often also be hazardous. The ability of a human to conduct these rounds and to be a viable sensor platform for detection or response is often limited. While the use of robots to reduce human workload and take on repetitive tasks is nothing new, this application in both security and mission-critical operational environments is a new field. For efficiency to be gained, robotic missions must be highly automated and configurable to expected conditions, but, adaptable to changing or unanticipated conditions using tools that produce predictable and reliable outcomes as well as predetermined responses to certain conditions and events. Since the conditions within live environments for these missions can change rapidly due to weather, changing terrain, operating requirements, or actual response, a robust mission design software is required. Further, the use of robotics in this field will allow companies to save on personnel costs, reduce potential insider threats and improve efficiency.

### DETAILED DESCRIPTION

The present disclosure provides a method and a system to implement using artificial intelligence for robotic mission planning for securing and inspecting all manner of sites, including high value government and commercial sites.

In one embodiment, the method includes creating a digital twin (or model) 10 of a site 20 and, using the digital twin 10, uses modeling and simulation to create numerous permutations 30 of the security system's response 40 for the site 20, which can serve as a platform for automation using artificial intelligence.

The digital twin 10 is a 3D model of the site 20 to be secured. The digital twin 10 may feature detailed representations buildings, fences, and gates (or other barriers), roads, terrain, vegetation, doors, sensors, and communication systems, etc. present at the site 20. The digital twin 10 can be created using any number of commercially available software packages including Autodesk®, ESRI, and MicroStation. The digital twin 10, once created, is stored in a machine readable, standards based, format such as the COLLADA™ file format for further processing by the mission planning software 50. The digital twin 10 provides real-world data that can be incorporated into the robotic mission planning method.

The mission planning for operations software 50 can be used to create many mission planning options for the site 20 and uses pathfinding algorithms coupled with Monte-Carlo/stochastic generated simulations to determine optimum pathing, response, and likely effectiveness of the plan for the site 20.

The mission planning software 50 includes a library of elements 60 important for robot operations, security missions, inspection missions and other missions including, but not limited to, elements 60 for detection of, delay of, response to, and neutralization of a security threat. In one embodiment, the mission planning software 50 comprises a pathing engine 70 for determining a path for a robotic unit 80 while in an alternate embodiment the mission planning software 50 is in communication with the pathing engine 70. By way of non-limiting security example, the mission planning software 50 and library of elements 60 for a site 20 could include information about various alarms, sensors, cameras, barriers, gates, responders, vehicles, and weapons that either are or could be, deployed on the site 20. In addition, the mission planning software 50 has detailed information about the potential threats and defenses including sensors, delay systems, weapons, armor, vehicles, breaching tools, and skill levels. Using the digital twin 3D model 10 and simulation functionality, the mission planning software 50 then can run hundreds or thousands of permutations 30 of various mission plans based upon the specifications for each element of the plan as well as each element working within a system of systems, combining the digital twin, sensors, weapons, adversaries, and personnel at a site. This digital twin 10 and modeling, along with robotic system integration, provides the backbone for highly automated unsupervised security and inspection missions and responses.

The mission planning software 50 will provide the infrastructure needed to automate robotic systems 90, which includes one or more robotic units 80, plan their missions, and determine the probability of success of a particular mission prior to execution within the field. As an example, the mission planning software 50 will allow operators to create a mission plan for a robotic system 90 that includes elements such as what areas to patrol, what sensors to employ, and when to activate these sensors (keeping sensors off allows battery life to be saved), determine the robots paths for missions such as security patrols or inspections, and calculate the probability of mission success. The mission planning software 50 will leverage the library of elements 60 which will be configured to a specific robotic system to model its performance over different terrain, weather and ground conditions, sensor use, and use of lethal or non-lethal weapons or inspection components. In another example, the mission could be used to provide perimeter sentry duty, i.e., the robotic unit 80 is tasked with patrolling a given area. The patrol route can be planned, and the robot system's sensors controlled, based on preplanned mission parameters or actual events such as the detection of a possible intrusion by other supporting sensors such as smart fences. Once such a detection is made and assessed, the robot will execute response plans such as rerouting the robotic unit 80 to another location based on supporting sensor data and then employing sensors, speakers, or other deterrent systems to defeat a threat or record the intruder. After the event, the system will either resume its route, or, through interaction with other robotic unit 80 acting as sentries, be relieved (automatically) to allow for recharging. The system and method are flexible and will allow for missions within missions based on location, event status, detection, time, or other configurable parameters. Although this is a simple example, the missions will gain complexity and capability over time. The system will be focused on creating missions that are highly unsupervised and autonomous. For instance, the system would create interdependent tasking for multiple robot units 80 such that robotic units 80 can coordinate, unsupervised, to accomplish sequential or nonsequential objectives within a mission—much the same as human beings would. For example, when a first robotic unit 80 accomplishes a planned task or has new information captured from onboard sensors, it sends new updated tasking parameters to a second robotic unit 80.

The mission planning software 50 will further allow simulation of the planned mission, computing the likelihood of mission success based on these simulations prior to starting a mission. This is a complex computation that requires the use of both the digital twin 10 and simulation engine to run scenarios to determine effectiveness of the sensor systems, and many other mission systems, against a modeled threat. Total robotic unit 80 energy consumption during the mission, based on models of the robot's energy consumption as a function of speed over various terrain types, topographies, and environmental conditions, as well as sensor use, communications load, and other relevant parameters, will be evaluated during the pathfinding and simulation phases of the mission development.

In one specific embodiment, the element 60 is a robotic unit 80, such as a drone, unmanned vehicle, or quadruped unmanned ground vehicle. The robotic unit 80 could be tasked with providing perimeter defense to a certain site 20. The mission planning software 50 in the embodiment can use the pathing engine 70 to determine, for example, the optimum path around the perimeter/interior of the site 20 the robotic unit 80 to execute its mission, then compute the probability of success of that mission against specified threats. The system and method allow the specifications of the robotic unit 80 to be integrated into the overall security system 40 plan such that the robotic unit 80 and the other present elements 60 function efficiently.

The robotic unit 80 will have multiple sensors 100 that gather information about the robotic unit's 80 surroundings. The robotic unit 80 may have infrared (IR) sensors, cameras, weather sensors, radar, lidar, etc.

It is desirable, but lacking in the prior art, for a user to be able to remotely control multiple robotic units 80 with one interface rather than relying upon separate controls for each robotic unit 80. This disclosure provides such capability. The present disclosure allows the control of multiple robotic units (multiple ground, aerial, counter UAS, surface water, or underwater drone systems) 80 from one interface so that the timing, path, and operational status of each robotic unit 80 can be viewed and modified accordingly. In addition, current disclosure provides the capability to operate multiple (up to 20 or more) robotic systems 90 in a combined or supportive mission. This allows minimal supervision when taking on complex tasks that require more than one robotic system 90.

The mission planning software 50 is in communication with each robotic unit 80, which allows real-time viewing and modification of each robotic unit's 80 timing, path, and operational status to be determined quickly. The present disclosure provides adaptive autonomy to the robotic unit 80 if the mission parameters were to change mid-mission, for example, if a robotic unit 80 malfunctions, if weather conditions change, or if an obstacle is encountered. This capability provides adaptive autonomy which allows the robotic unit 80 to determine if the pre-planned mission needs to change. Although not believed to be necessary, for one skilled in the art, the following examples of adaptive autonomy are illustrative.

In one example, a robotic unit 80 could be tasked with patrolling along a certain path for a set period of time. However, the discharge rate of a battery can be influenced by many factors, including temperature. So, if the temperature were to rapidly fall below the expected range, a robotic unit's 80 battery may not last until the predetermined end of the mission. The current disclosure provides, through the use of the mission planning software 50, autonomy for the robotic unit 80 to end its mission due to low battery change before the predetermined time, be routed for charging and for another robotic unit 80 to be dispatched to finish the mission.

In another example, a robotic unit 80 encounters a problem with one of its subcomponents such as a leg overheating. The mission planning software 50 will automatically modify the mission to slow the pace of the robot, allowing the mission to continue by matching the mission parameters to the robot's degraded condition. If the new mission does not meet strategic goals, the system will disrupt the mission and send the robot back to its base of operations for repairs. As part of this scenario a “back-up” or relief robot could be dispatched automatically to continue the original mission.

In another example, the digital twin 10 could include “exclusion zones” in which the robot is not allowed to operate. If the robot, as a part of a poorly planned mission or a failed sensor, approaches an exclusion zone, an alert will be generated to allow the operator to take corrective action. If the robot continues it will be automatically shut down once it crosses into the exclusion zone.

In another example, a robotic unit 80 could encounter an unexpected obstacle, natural or manmade, that prevents it from proceeding on its path. Adaptive autonomy for the robotic unit 80 provides for the capability to find and plan a path around the obstacle. The path, for example, may have a number of waypoints selected and, depending on the situation, the robotic unit 80 may autonomously redirect itself to a previous waypoint for rerouting. This same example could be expanded to include updated maps, with enemy locations or gun emplacements that that would allow the system and method to automatically update the pathing of the ground robotic system to, for example, avoid firepower, or to take cover and concealment based on terrain. This would all happen in near real time with updated map details or changing mission requirements.

The system will allow for an almost unlimited number of missions, and submissions based on events, outcomes, locations, or preplanned responses. This will allow an elevated level of autonomy and significant improvement of efficiency for robotic fleet operations.

In one preferred embodiment for robotic mission planning for a security mission, the method can be outlined as follows:

1. First, create an accurate digital twin 10 that includes roads, paths, terrain, barriers, buildings, infrastructure, delay systems, etc. of the site to be secured.

2. Second, characterize details using mission planning software 50 library of elements 60, including the robotic unit 80.

3. Third, use the pathing engine 70 to identify candidate missions.

4. Fourth, use the Monte Carlo simulation and pathing engines 70 of the mission planning software 50 to measure the effectiveness of each candidate mission. This enables the mission planning software 50 to identify, for example, the most effective path for each robotic unit 80 to patrol, and thus provides the maximum level of security to the site 20. Additionally, the likelihood of success of a mission can be determined with improves mission assurance. The simulation may subsequently be modified to match updated information from the site and rerun. This allows the system to check that the chosen path remains the best and most efficient.

5. The mission planning software 50 will output various scenarios, for example, paths for the robotic unit 80 to patrol, and may rank these paths by effectiveness as well as by timing. The present disclosure accounts for both the robotic unit's 80 specifications as well as the digital twin's 10 in determining which paths are most likely to be successful. The generated paths will be dependent on the mission requirements, robotic systems used, sensors used, and duration of the missions.

6. After plans are generated, the robotic units 80 will be dispatched on their paths at the prescribed time, using prescribed sensors with predetermined submissions, and the ability to update in real time as mission parameters change.

These updates are based on continuous monitoring of the health of the overall mission, the robot, and the robot's subsystems. The system can easily display health and battery use, as well as all robotic sensor outputs. These outputs can be easily displayed and integrated to existing base or security operations systems.

Other aspects of one embodiment of the system and method are described in more detail below but are provided for exemplary purposes only and should not be considered limiting in any manner.

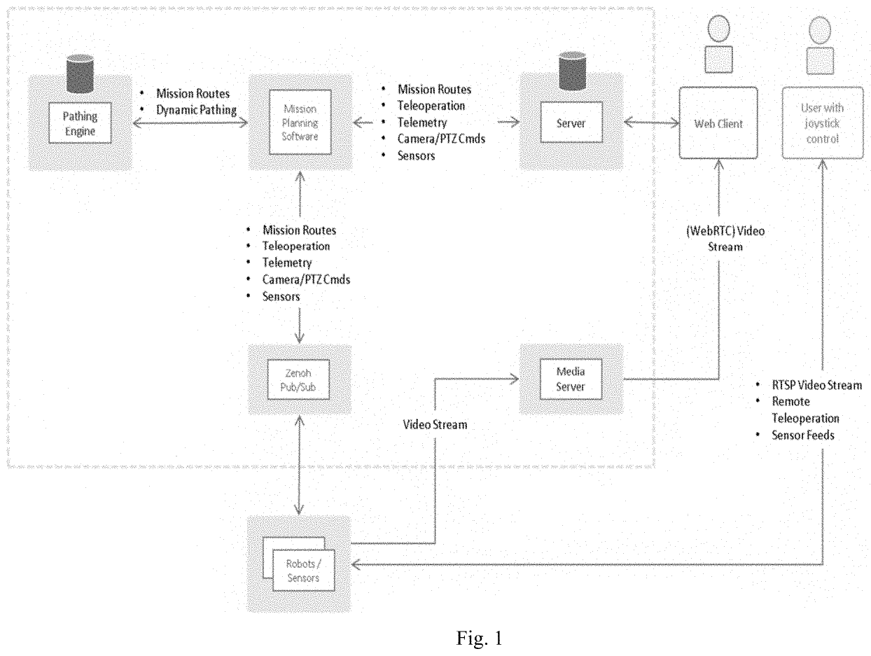

FIG. 1 shows one example of a system architecture/flow chart capable of achieving the above capability. This diagram describes the basic architecture of the system and method. As outlined, the mission planning software 50 is used to both generate paths for the automated robotic systems 90 via the pathing engine 70, as well as simulate the robotic systems 90 executing these paths so the probability of the success of the mission can be calculated. This takes advantage of the unique algorithms and libraries within the mission planning software 50 to allow robotic systems 90 to be properly pathed using not just detailed terrain from the digital twin 10, but also the unique characteristics of this model such as cover and concealment points, fastest path over specific terrain, avoiding barriers, optimizing detection location, interdiction points and other criteria. Further the simulation engine also contains unique library entries to each robotic system 90 including ground robots, drone, counter drone, or other systems. Each of these systems will have unique capabilities and characteristics for performance and battery usage across different terrains and in different conditions. Each of these unique “performance characteristics” as well as any sensor payload are included in the library. This allows the pathing engine 70 to not only find the best path under conditions but to also predict the potential success (based on time, battery life, detection requirements or interdiction requirements) of the mission prior to the start.

The pathing engine 70 interfaces through an interface. This interface interprets the robotic systems to be utilized, mission routes, sensor requirements and use, telemetry or bandwidth priorities, and objectives to be processed from the user 110 or web client 120 via a server 130 into the pathing engine 70. Similarly, the interface also incorporates information from the actual sensors/robot to calculate health and detection. This information is critical to determine if the mission is on plan and the robotic system is on mission. Information relative to sensor output in the form of telemetry, video, infrared sensors, or other outputs are also sent to a media server 140 which can also be presented through a web-client interface 150. The web client 120 is used to both plan and modify the missions but also to monitor individual or fleet robotic system operations. The specific robotic information including alarms or alerts, sensor output, health information, and location can then be processed into any operation center or physical security information management System (PSIM). Accordingly, the robotic units 70 can transmit real-time data back from the field to the user 110, no matter if the user 110 is at a mission control center, using a hand held device or PSIM.

Robotic operation can also be overridden or supplemented with joystick supplemental controls by the user 110. This is necessary if a mission requires human interaction or “man in the middle” decision making.

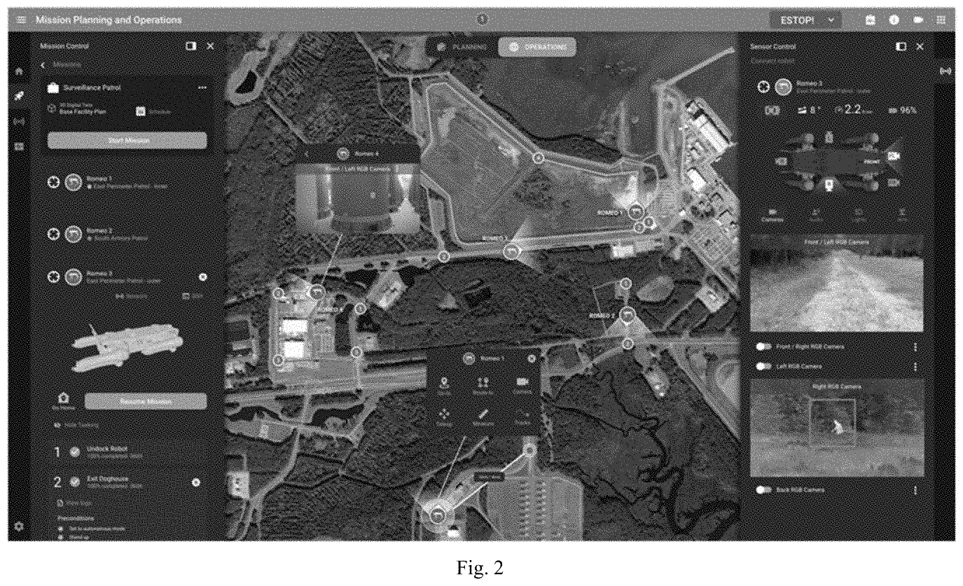

FIGS. 2-10 show various embodiments of screen shots showing the web client interface 150 or other user facing aspects of one embodiment of the disclosed system and method.

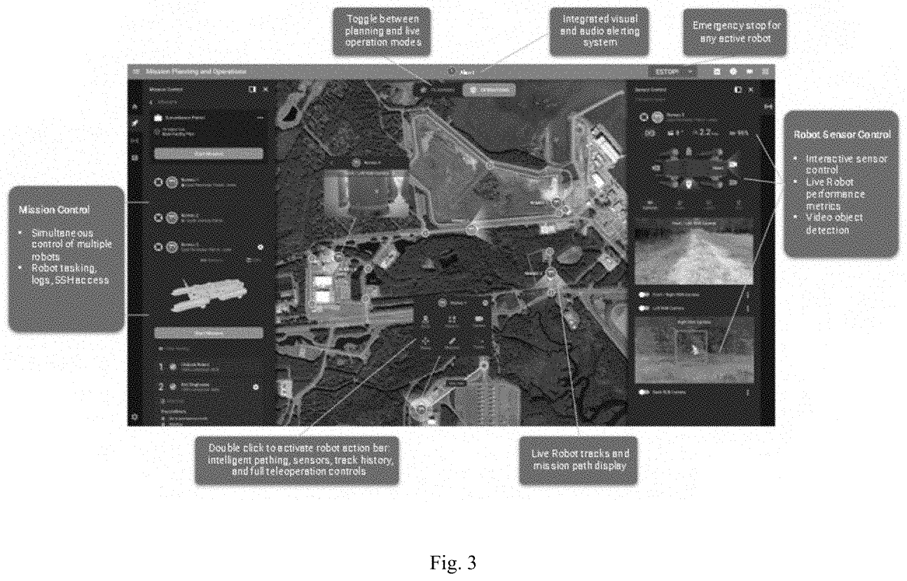

FIG. 2 shows one embodiment of the web client interface that is used for planning and for managing mission operations. FIG. 3 shows one embodiment of a mission operation screen to allow monitoring of an ongoing mission or set of missions.

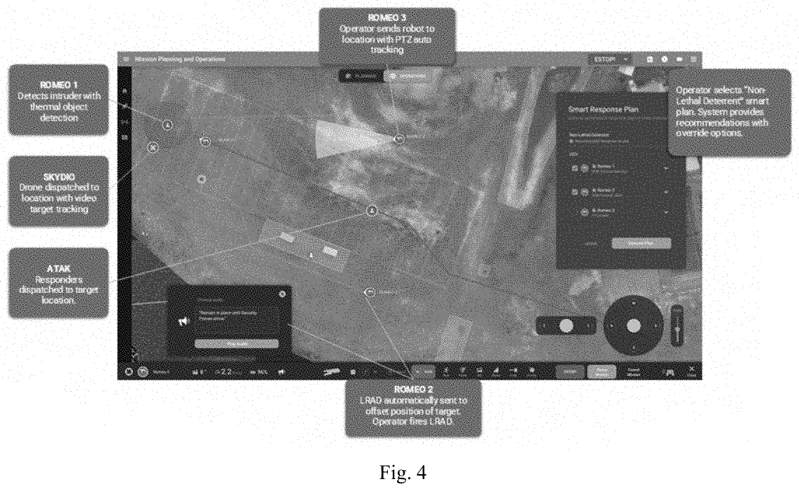

FIG. 4 highlights several components of the mission operation screen of FIG. 3. The annotations in FIG. 4 highlight key features of the system that are unique to multi-robotic mission planning and management. The components such as mission control (simultaneous control of multiple robots, robotic tasking, mission logs, sensor access), robotic sensor control (interactive sensor control, live robotic performance data, video, or sensor display), live tracking of robots and capability to set deviation from path alarms, at pass over double click screen capability to view detailed action of the robotic system (such as intelligent planned path, sensor status, history tracking and full teleoperations)

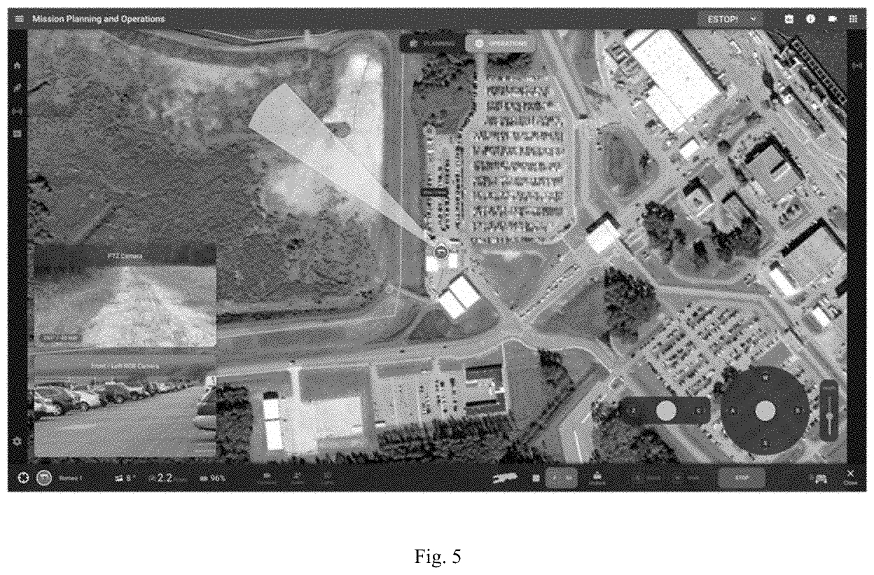

Similarly, for multiple robotic missions, the system provides overview screens that depict multiple robots performing their individual missions as shown in FIG. 5. This figure shows multiple robotic units 80 and aerial systems (Romeo 1, Romeo 2 and Romeo 3 are ground based robotic systems, while Skydio® is an aerial system). Similarly, this screen is interactive and allows interaction with any robotic mission in order to provide mission overview, smart response plans and recommendations, and override options per system. This smart interface interacts with the digital twin 10 and robotic system libraries to ensure that missions are only assigned to available robotic systems with the capabilities to successfully execute them. The system is agnostic as to what robotic systems are used.

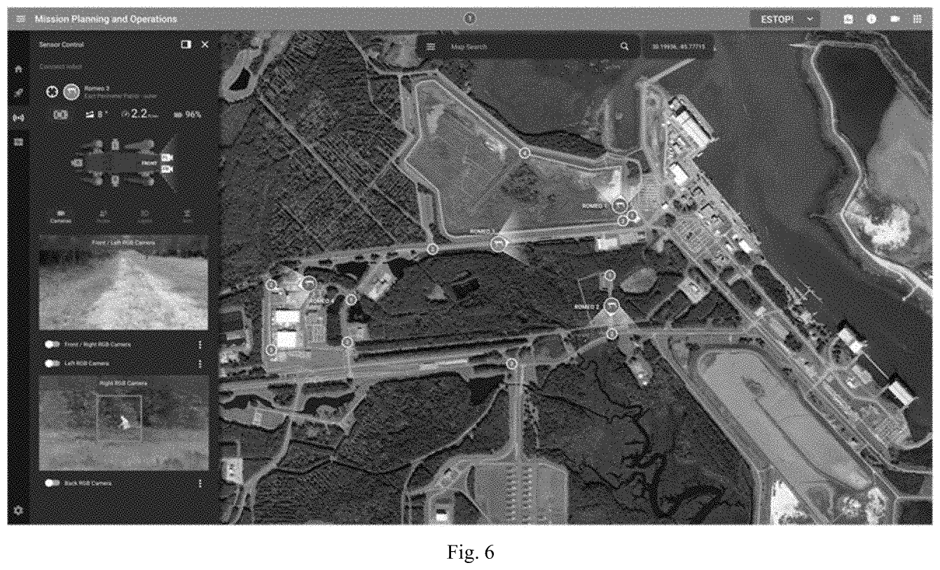

FIG. 6 shows a robotic system on a planned path in blue. The starting point (white circle), end point (blue circle) and current location of the system (robot icon) are provided. The system's cameras (which could be any sensor) are displayed on the bottom left and a camera cone (area of detection) is provided overlayed on the digital twin terrain model, based on information from the unique library of sensor performance characteristics.

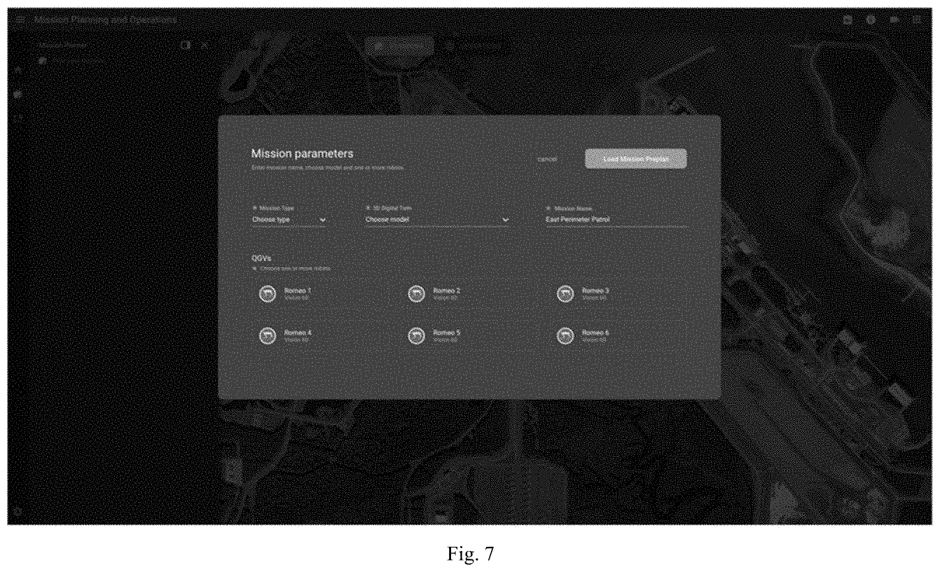

FIG. 7 shows an example of a live mission experiencing a component failure. The robotic system overview on the top left shows a red component (in this case a high temperature alarm). The main screen also shows the robot in red indicating an alarm condition. Alarm conditions can be configured based on any system performance or sensor output.

Although these screen shots provide the basic overview of one embodiment of live operational capabilities of the system and method of the present disclosure, they are highly configurable to individual robotic system, mission, and integration requirements. The integrations to the digital twin, performance library and sensors are also extensible to any type of robotic system, terrain (including aerial, water surface or subsurface, ground, or internal structures), or sensors/systems (including lethal or non-lethal deterrents). The web client is based on a table driven, services oriented multi-tenant architecture that will allow significant increased configuration, internationalization and mission capability as the robotic market and the missions mature.

In addition to live operations monitoring, the web client also provides mission planning input screens to set up individual missions.

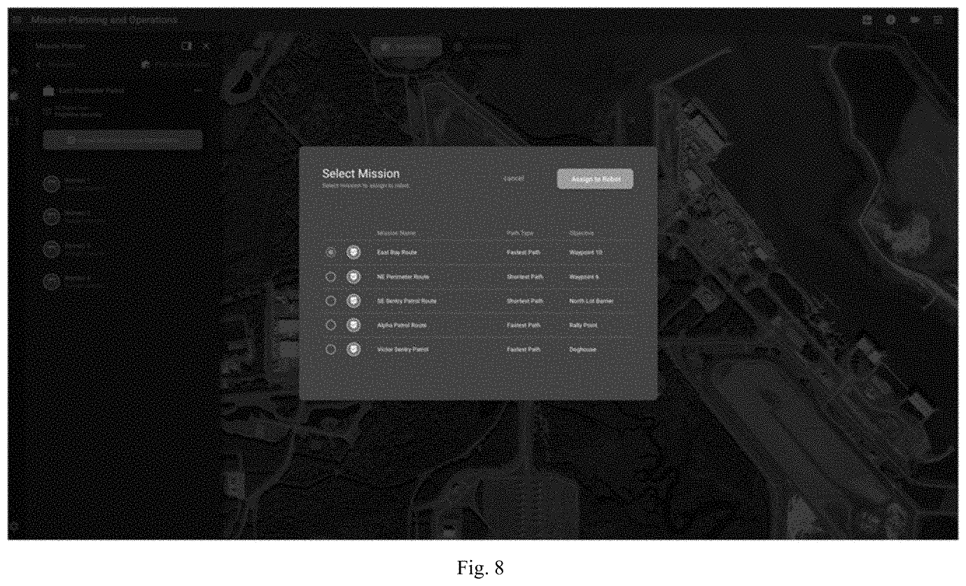

FIG. 8 shows the selection of the robotic system and digital twins required for the initial mission. The individual systems will be pulled from a library of support robotic systems. Digital twin models will be associated with individual missions.

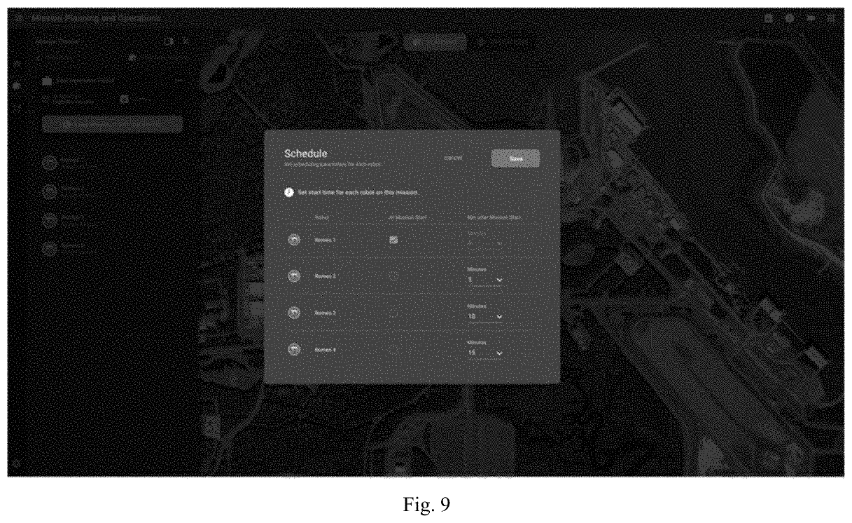

FIG. 9 shows the schedule planning for a mission based on time or delay or start.

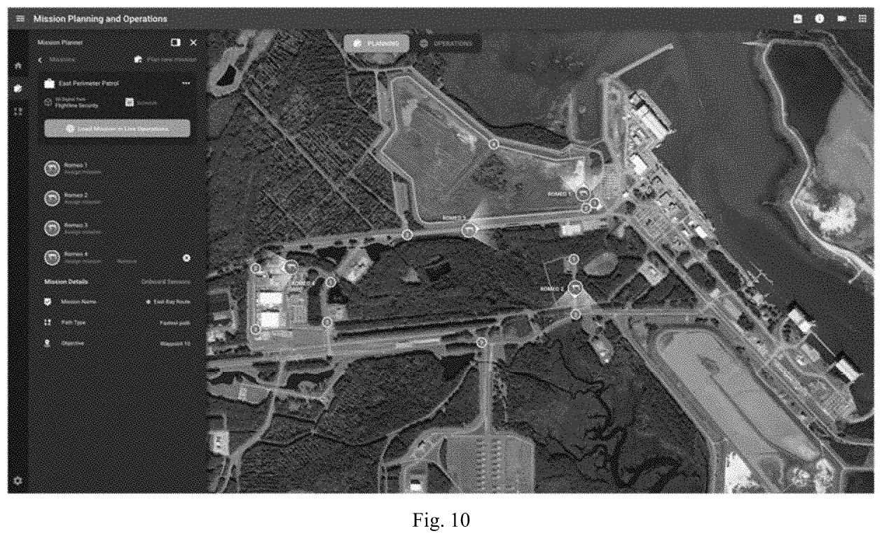

FIG. 10 shows the visual display of a mission or set of missions. This is to allow the mission planner to visualize the mission prior to loading it into live operations. These screen shots are not an exhaustive list, but examples of the detailed planning screens included in the system and method.

The method and system disclosed herein offer several key advantages over the prior art, including:
The ability to preplan missions and preplan robotic responses within missions (mission in mission) to alerts, alarm conditions or events, which significantly reduces load on operators, especially for routine events such as recharging, relief, or back-up support.
The ability to operate multiple robotic systems (aerial, ground or water/subsurface) from a single mission planning system, which also greatly reduces operator load but also reduces need to learn multiple robotic system interfaces.
The ability to pre-determine mission success rate, battery usage or sensor package effectiveness based on terrain or mission specific parameters prior to launching mission.
The ability to use adaptive pathing as events change, allowing re-pathing to reoptimize mission effectiveness in changing conditions.
Highly configurable web-client interfaces, sensor integration and map/digital twin access, providing ease of use and intuitive use depending on client or mission objectives.
The ability to optimize battery usage across multiple robotic systems by sensor management (turning sensors on and off during mission) based on time, location, alarm, or event status. Battery usage is also optimized by referencing unique robotic system libraries modeling power demand across different terrains, and in combination with sensors.

Although particular embodiments of the present disclosure have been described, it is not intended that such references be construed as limitations upon the scope of this disclosure except as set forth in the claims.

We claim:

1. A method of using robotic units to provide security for a site, the method comprising:
a. creating a digital twin of the site;
b. using a pathing engine to model and determine possible robotic unit paths around the site; and
c. using the digital twin and possible robotic unit paths to create numerous permutations of a security mission plan for the site.

2. The method of claim 1 wherein the pathing engine considers topography in determining possible robotic unit paths.

3. The method of claim 1 wherein the digital twin includes at least one of the following features of the site buildings, fences, and gates (or other barriers), roads, terrain, vegetation, doors and sensors.

4. The method of claim 2 wherein the digital twin includes at least one of the following features of the site buildings, fences, and gates (or other barriers), roads, terrain, vegetation, doors and sensors.

5. The method of claim 4 wherein the digital twin includes at least two of the following features of the site buildings, fences, and gates (or other barriers), roads, terrain, vegetation, doors and sensors.

6. The method of claim 1 wherein Mone Carlo simulation is used to create the numerous permutations of a security plan for the site.

7. The method of claim 5 wherein Mone Carlo simulation is used to create the numerous permutations of a security plan for the site.

8. The method of claim 1 wherein at least one of the possible robotic unit paths is a path around the perimeter of the site.

9. The method of claim 6 wherein at least one of the possible robotic unit paths is a path around the perimeter of the site.

10. The method of claim 1 wherein the possible robotic paths may be altered after implementation due to environmental factors which affect the robotic unit.

11. The method of claim 1 wherein the possible robotic paths may be altered after implementation due to mechanical factors which affect the robotic unit.

12. The method of claim 1 comprising at least two robotic units.

13. The method of claim 2 comprising at least five robotic units.

14. The method of claim 1 wherein the robotic units comprise both terrestrial and aerial robotic units.

15. The method of claim 12 wherein the robotic units comprise both terrestrial and aerial robotic units.

16. The method of claim 1 wherein the robotic units are monitored in real time as they progress along a possible robotic path.

17. The method of claim 2 wherein the robotic units are monitored in real time as they progress along a possible robotic path.

18. The method of claim 15 wherein the robotic units are monitored in real time as they progress along a possible robotic path.
